(19) United States
(12) Patent Application Publication
(10) Pub. No.: US 2010/0211596 A1
(43) Pub. Date: Aug. 19, 2010

(54) SYSTEMS FOR REPLACING THE DEFAULT CURSOR IMAGE DISPLAYED ON A CLIENT COMPUTER OR TERMINAL

(75) Inventor: Savio Yu Kwong TANG, Hong Kong (HK)

Correspondence Address: JONES DAY, 29TH FLOOR, EDINBURGH TOWER, THE LANDMARK,, 15 QUEEN'S ROAD, CENTRAL, HONG KONG, CN

(73) Assignee: Cosher Limited, Central (HK)

(21) Appl. No.: 12/700,708

(22) Filed: Feb. 4, 2010

Related U.S. Application Data
(60) Provisional application No. 61/207,664, filed on Feb. 17, 2009.

(51) Int. Cl. G06F 17/30

(52) U.S. Cl. 707/769; 707/E17.03

(57) ABSTRACT

Provided herein are, among other things, systems for transmitting and displaying a custom-designed digital or cursor image on at least one screen or video monitor or display of a remote or client computer or an electronic terminal. The systems may override or replace the default cursor image on the client computer or terminal. The systems may get or receive a cursor display request instruction or electronic request through a network. The systems may choose or select the appropriate custom-designed digital or cursor image from a database or repository based on the URI or network domain address of the network content or website being viewed on the client computer or terminal. The systems may then transmits the cursor information and cursor image to the requesting terminal to be displayed on the remote screen. The systems may keep track of all transmission records and store such records or data in a database.

### PRIOR RELATED APPLICATIONS

This patent application claims priority to U.S. Provisional Patent Application No. 61/207,664, filed on Feb. 17, 2009, which is incorporated herein by reference in its entirety.

### FEDERALLY SPONSORED RESEARCH STATEMENT

Not applicable.

### REFERENCE TO MICROFICHE APPENDIX

Not applicable.

### FIELD OF THE INVENTION

Provided herein are, among other things, systems for overriding or replacing a default displayed cursor image on a remote or client computer or terminal, and particularly systems for delivering custom-designed digital images to client computers or terminals to replace default local cursor images on the client computers or terminals.

### BACKGROUND OF THE INVENTION

Advertising on the internet or the World Wide Web (or simply referred to as “the web”) has not shown major innovation in recent years. Advertisements are generally delivered as banners, pop-up windows, pop-up “flash” boxes, and text-based advertisements embedded in email messages. There have not been any major innovations in the way advertisements are delivered. Google Inc.'s Adwords and Adsense services may allow some intelligence to be performed on the content of web pages and deliver advertisements accordingly. However, this is merely an incremental improvement over old ways or models.

One of the most common forms of online advertisement is banner advertisement, or simply referred to as “banner-ad”. Banner-ads generally contain a hyperlink, which when clicked on by a viewer, it will direct the viewer to the advertiser's website promoting its services, products, or messages. Unfortunately, banner-ads generally occupy only a small area of a web page and may become hidden when the viewer scrolls down the web page. Also, banner-ads have become such a commonplace that many viewers tend to ignore them.

Another form of online advertisement is the pop-up window or pop-up “flash” box. Pop-up window advertisements are delivered when a viewer or user visit a website that contains such advertisements. Software codes embedded in the website instruct the viewer's computer to open a new browser window which is directed to the advertiser's website. Pop-up window advertisements are considered ineffective because many viewers consider them a nuisance. Many browsers and/or add-on software to browsers may have the ability to block such pop-up windows from being triggered. Pop-up “flash” boxes are another popular form of online advertisement. A pop-up “flash” box is generally not another browser window, but a rectangular-shaped box or frame containing images, video clips, audio signals, animation codes or a combination thereof. In some embodiments, the pop-up “flash” box may be implemented in Adobe Inc.'s popular Flash software. These pop-up “flash” boxes can deliver a rich content to attract the viewer's attention. However, this form of online advertisement may be considered intrusive by some viewers because the viewers have no control on the triggering of the advertisements. Furthermore, the advertisements may obstruct the view of the original content of the underlying web page temporarily.

Therefore, there is a need for a method or system to deliver online advertisements that can attract the viewer's attention but remain un-intrusive to the viewer's view and/or activity.

### SUMMARY OF THE INVENTION

Provided herein are systems for delivering custom-designed cursor images to client computers or terminals to replace the default local cursor images on such client computers or terminals.

In one aspect, provided herein is a system for transmitting a digital image to replace a cursor image associated with a website or web page displayed at a client computer or terminal, the system comprising:

a) a computer server system connected to the internet;

b) a database containing mapping information for pairing, matching or coupling the URI of the website or web page with the digital image;

c) a first set of software codes operable to receive and transmit instructions or data through the internet;

d) at least one web server connected to the internet, wherein the web server hosts the web page or website; and

e) a second set of software codes operable to generate at least one cursor display request instruction and to transmit the cursor display request instruction to the computer server system,

wherein the database and the first set of software codes reside in the computer server system, and wherein the second set of software codes is embedded in the web page or website, and wherein the first set of software codes is further operable to process the cursor display request instruction, to search the database for the digital image corresponding to the URI, and to transmit the digital image to replace the cursor image displayed at the client computer or terminal.

In another aspect, provided herein is a system for transmitting a digital image to replace a cursor image associated with a website or web page displayed at a client computer or terminal, the system comprising:

a) a computer server system connected to the internet;

b) a first set of software codes operable to receive and transmit instructions or data through the internet;

c) a database server system connected to the internet or to the computer server system;

d) a database containing mapping information for pairing, matching or coupling the URI of the website or web page with the digital image;

e) at least one web server connected to the internet, wherein the web server hosts the web page or website; and

f) a second set of software codes operable to generate at least one cursor display request instruction and to transmit the cursor display request instruction to the computer server system,

wherein the first set of software codes resides in the computer server system, the database resides in the database server, and the second set of software codes is embedded in the web page or website, and wherein the first set of software codes is further operable to process the cursor display request instruction, to search the database for the digital image corresponding to the URI, and to transmit the digital image to replace the cursor image displayed at the client computer or terminal.

In some embodiment, the system disclosed herein further comprises a third set of computer software code operable to interact with the database to transmit the digital image to the client computer or terminal.

In certain embodiment, the database disclosed herein contains mapping information for pairing, matching or coupling the URI and one or more keywords with the digital image. In some embodiment, the one or more keywords comprise statistics or data that describe the configuration of the client computer or terminal. In other embodiment, the one or more keywords comprise information related to the manufacturer, operating system, and configuration of the client computer or terminal; and information related to hardwares, browsers, and applications installed on the client computer or terminal. In further embodiment, the one or more keywords comprise text describing the type of content on one or more affiliated web pages or websites. In still further embodiment, the one or more keywords comprise text of syntax that is specially defined and understandable by the first set of software codes.

In some embodiment, the digital image disclosed herein is a static image. In other embodiment, the digital image is an animated cursor.

In certain embodiment, movements of the cursor image or the digital image are tracked by the second set of software codes and data related to the movements of the cursor image or the digital image are sent back to the computer server system for further processing by the first set of software codes. In some embodiment, the data related to the movements of the cursor image or the digital image comprise a record of the positions and movements of the cursor image or the digital image and buttons pressed.

In some embodiment, the digital image is configured to respond to the movements of a user of the client computer or terminal and to trigger one or more applications on the client computer or terminal.

In certain embodiment, the client computer or terminal does not comprise a mouse. In certain embodiment, the client computer or terminal comprises a touch screen control.

In some embodiment, the client computer or terminal comprises a detector that tracks eyeball movements of a user of the client computer or terminal and use the eyeball movements to command the digital image or the cursor image.

### DESCRIPTION OF THE DRAWINGS

FIG. 1 depicts an embodiment of the system disclosed herein. The system 10 comprises a computer server system 2, one or more web servers such as web servers 3 and 4, and one or more client computers or terminals such as client computers 5, 6 and 7. The computer server system, web servers, and client computers or terminals are connected to and communicated with each other through the internet 1.

FIG. 2 depicts an embodiment of the system disclosed herein. The system 20 comprises a computer server system 2, a database server 8, one or more web servers such as web servers 3 and 4, and one or more client computers or terminals such as client computers 5, 6 and 7. The computer server system, web servers, and client computers or terminals are connected to and communicated with each other through the internet 1. The database server 8 is connected to and communicated with the computer server system 2 through a fixed or wireless connection.

FIG. 3 depicts a flowchart diagram of an embodiment of the system disclosed herein for delivering one or more digital images to a client computer or terminal to replace the default local cursor image on the client computer or terminal.

### DEFINITIONS

The term “Uniform Resource Identifier” or “URI” refers to a string of characters used to identify a name or a resource on the Internet. Such identification enables interaction with representations of the resource over a network (such as the World Wide Web) using specific protocols. Schemes specifying a concrete syntax and associated protocols define each URI. URI can be classified as a Uniform Resource Locator (URL), a Uniform Resource Name (URN) or both. In general, the URN defines an item's identity, while the URL provides a method for finding it. A URL is a URI that, in addition to identifying a network-homed resource, specifies the means of acting upon or obtaining the representation, through description of the primary access-mechanism, or network “location”. A Uniform Resource Name (URN) is a URI that identifies a resource by name, in a particular namespace. One can use a URN to talk about a resource without implying its location or how to access it. The resource does not need to necessarily be network-homed.

The term “web address” or “network domain address” refers to web identifiers such as URI, URL and URN. More details about web identifiers can be found in the report by Network Working Group, titled “Report from the Joint W3C/IETF URI Planning Interest Group: Uniform Resource Identifiers (URIs), URLs, and Uniform Resource Names (URNs): Clarifications and Recommendations,” RFC3305 (2002), which is incorporate herein by reference.

The term “Bluetooth” refers to an industrial specification for wireless personal area networks (PANs). The Bluetooth specifications are developed and licensed by the Bluetooth Special Interest Group. Generally, Bluetooth provides a way to connect and exchange information between devices such as mobile phones, laptops, PCs, printers, digital cameras, and video game consoles over a secure, globally unlicensed short-range radio frequency.

The term “Wi-Fi” refers to the embedded technology of wireless local area networks (WLAN) based on the IEEE 802.11 standard licensed by the Wi-Fi Alliance. Generally, the branding Wi-Fi-CERTIFIED is tested and certified by the Wi-Fi-Alliance. Wi-Fi includes the generic wireless interface of mobile computing devices, such as laptops in LANs. Some non-limiting common uses of Wi-Fi technology include internet and VoIP phone access, gaming, network connectivity for consumer electronics such as laptops in LANs.

The term “ZigBee” refers to an industrial specification for wireless personal area network (WPAN) based on the IEEE 802.15.4 standard. IEEE 802.15.4 defines a robust radio (PHY) and medium access control (MAC) layer, and ZigBee defines the network, security and application framework for an IEEE 802.15.4-based system. The ZigBee Alliance tests and certifies ZigBee Compliant Platforms. Zigbee technology may be used for low-data rate wireless applications, such as industrial control, embedded sensing, medical data collection, smoke and intruder warning, building automation and home automation.

The term “server application” refers to an application program that accepts connections in order to service requests by sending back responses. Generally, a server application may run on the same computer as the client application using it, or they may connect through a computer network.

The term “local area network” or “LAN” refers to a computer network covering a small geographic area, like a home, office, or group of buildings. Generally, a LAN has a higher data transfer rates and smaller geographic range than a wide area networks (WANs). Some non-limiting examples of local area network technology include Ethernet over twisted pair cabling, Bluetooth, Wi-Fi, Zigbee, ATM, ARCNET, Token Ring and the like.

The term “smartphone” refers to a mobile phone offering advanced capabilities, such as PC-like functionality. In some embodiments, the smartphone includes phones that run a complete operating system software providing a standardized interface and platform for application developers. In other embodiments, the smartphone includes phones with advanced features such as e-mail, internet and/or e-book reader capabilities. In further embodiments, the smartphone includes a built-in full keyboard or external USB keyboard and/or VGA connector. In certain embodiments, the smartphone includes computers that have phone capability.

### DESCRIPTION OF EMBODIMENTS OF THE INVENTION

The system disclosed herein comprises at least one computer server system on which at least one database resides. The database stores or comprises custom-designed digital or cursor images to be used as advertisements and also information that facilitates the matching of digital images to the domain addresses or URI's of web pages or websites. The system disclosed herein has at least one connection to the internet or a network through which it connects to one or more client computers or terminals.

Where one or more advertisements are placed on a website or web page hosted in a web server, there is a set of software codes resided in the web server and/or embedded in the website or web page. When a user or viewer uses a client computer or terminal to visit the website or web page, the instructions provided by the software codes are transmitted to the computer server system to request for a custom-designed digital or cursor image corresponding to the domain address or URI of the web page or website. The computer server system may contain another set of software codes that searches the database for the custom-designed digital image, and then transmits the custom-designed digital image to the client computer or terminal to be displayed on its screen or monitor. The computer server system may record the event into its internal log and/or the database.

In one aspect, provided herein is a system for transmitting a digital image to replace a cursor image associated with a website or web page displayed at a client computer or terminal, the system comprising:

a) a computer server system connected to the internet;

b) a database containing mapping information for pairing, matching or coupling the URI of the website or web page with the digital image;

c) a first set of software codes operable to receive and transmit instructions or data through the internet;

d) at least one web server connected to the internet, wherein the web server hosts the web page or website; and

e) a second set of software codes operable to generate at least one cursor display request instruction and to transmit the cursor display request instruction to the computer server system,

wherein the database and the first set of software codes reside in the computer server system, and wherein the second set of software codes is embedded in the web page or website, and wherein the first set of software codes is further operable to process the cursor display request instruction, to search the database for the digital image corresponding to the URI, and to transmit the digital image to replace the cursor image displayed at the client computer or terminal.

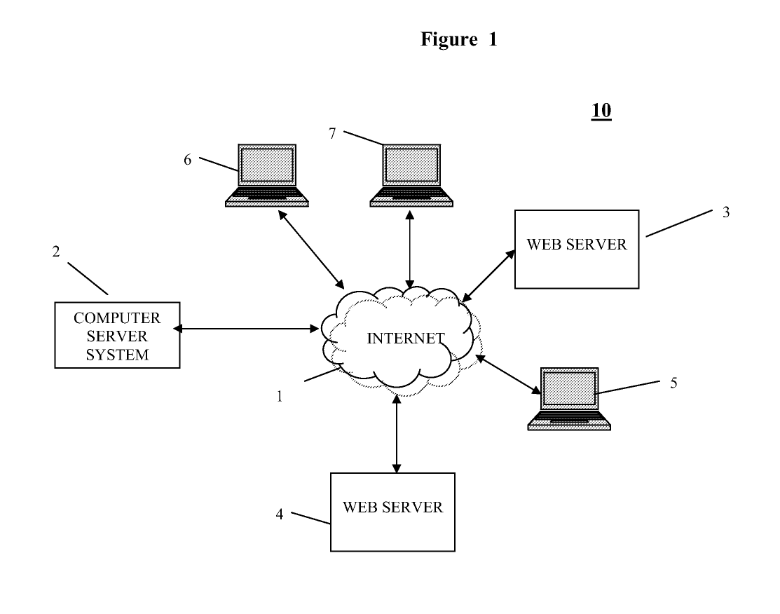

FIG. 1 depicts an embodiment of the system disclosed herein. The system 10 comprises a computer server system 2, one or more web servers such as web servers 3 and 4, and one or more client computers or terminals such as client computers 5, 6 and 7. The computer server system, web servers, and client computers or terminals are connected to and communicated with each other through the internet 1. The computer server system stores or comprises a database containing mapping information for pairing, matching or coupling the URI with the digital image and a first set of software codes operable to receive and transmit instructions or data through the internet. The web servers host web pages or websites and a second set of software codes embedded in the web pages or websites operable to generate at least one cursor display request instruction and to transmit the cursor display request instruction to the computer server system.

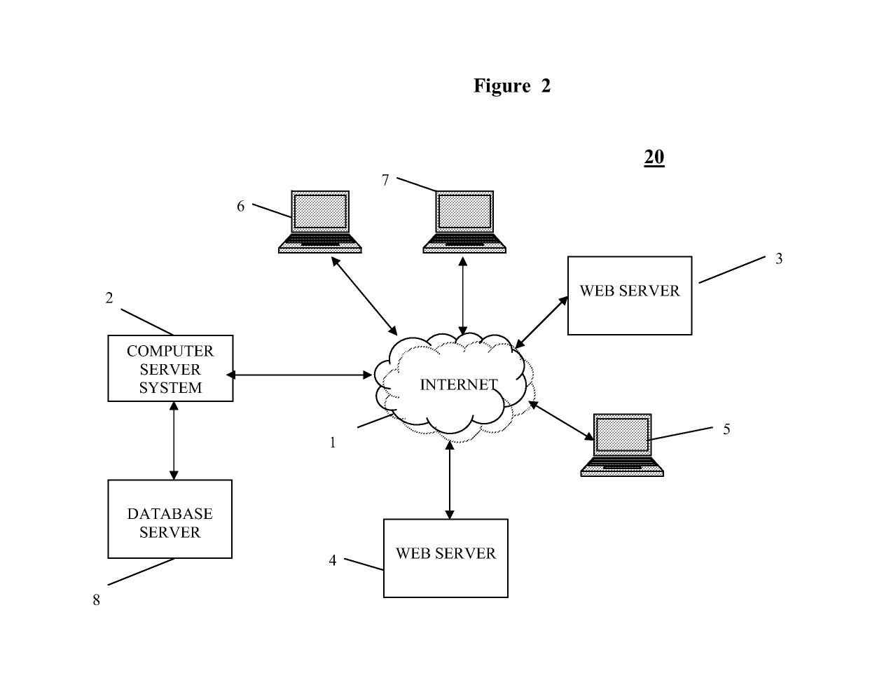

FIG. 2 depicts an embodiment of the system disclosed herein. The system 20 comprises a computer server system 2, a database server 8, one or more web servers such as web servers 3 and 4, and one or more client computers or terminals such as client computers 5, 6 and 7. The computer server system, web servers, and client computers or terminals are connected to and communicated with each other through the internet 1. In some embodiments, the database server 8 is connected to and communicated with the computer server system 2 through direct connection. In other embodiments, the database server 8 is connected to and communicated with the computer server system 2 wirelessly. In further embodiments, the database server 8 is connected to the internet and communicated with the computer server system 2 through the internet. The database server 8 is connected to and communicated with the computer server system 2 through direct link. The database server stores or comprises a database containing mapping information for pairing, matching or coupling the URI with the digital image. The computer server system stores or comprises a first set of software codes operable to receive and transmit instructions or data through the internet. The web servers host web pages or websites and a second set of software codes embedded in the web pages or websites operable to generate at least one cursor display request instruction and to transmit the cursor display request instruction to the computer server system.

The system 10 or 20 may comprise a worldwide network of servers such as computer server system 2, and web servers 3 and 4 which are accessible by client computers or terminals 5, 6 and 7. The client computers or terminals 5, 6 and 7 generally are used by individual users. The computer server system 2, the web servers 3 and 4 and the client computers or terminals 5, 6 and 7 are connected with each other through the internet by any method known to skilled artisans. In certain embodiments, one or more of the computer server system, the web servers and the client computers or terminals are interconnected via a Local Area Network or LAN. In some embodiments, one or more of the computer server system, the web servers, the client computers or terminals and the LAN are capable of accessing the internet directly or indirectly via an internet service provider (ISP) through a phone line, a DSL line or a cable modem. In certain embodiments, one or more of the computer server system, the web servers, and the client computers or terminals are connected to the internet by a modem (such as phone modems, DSL modems, cable modems and wireless modems) or a node on a local-area network. In other embodiments, one or more of the computer server system, the web servers, and the client computers or terminals are capable of accessing the internet wirelessly by Bluetooth, Wi-Fi, ZigBee, and the like.

In certain embodiments, the client computers or user terminals 5, 6 and 7 includes a web browser loaded on the client computer's hard drive. A web browser is a common software tool which allows, inter alia, graphical user interface (GUI)-based access to computer server system 2, and web servers 3 and 4 through the internet. Any web browser that can be used for retrieving, presenting, and traversing information resources on the World Wide Web, can be used herein. Some non-limiting examples of web browser include Internet Explorer, Netscape Navigator, Opera, Safari, Firefox, WebKit-based web browsers and web browsers for mobile phones. Some non-limiting examples of the WebKit-based web browsers include Google's Chrome and other WebKit-based web browsers running in various mobile phone platforms, including the iPhone OS, Google Android, Nokia S60 and Palm WebOS. Web servers 3 and 4 may host one or more websites or web pages. The websites may support and maintain a plurality of files in the form of documents and web pages. Each website or web page has a unique URI.

The client computer or terminal can be any computer or devise that is configured to connect to the internet by any connection method disclosed herein and to run any web browser disclosed herein. The client computer or terminal can be a mainframe computer, a minicomputer or workstation, a personal computer or a smartphone. Some non-limiting examples of the personal computers include various desktop computers, laptop computers, portable computers, nettop computers, notebook computers, home theater PC's and other mobile computers. Some non-limiting examples of the mobile computers include tablet PC, ultra-Mobile PC, pocket PC, and handheld PC. Some non-limiting examples of smartphones include all smartphones using the Symbian OS, iPhone OS, Palm WebOS, BlackBerry OS, Samsung bada, Windows Mobile, Android or Maemo operating system. In some embodiments, the smartphones include Google's Nexus One using the Android open source mobile operating system, Research In Motion's various Blackberry smartphones using the BlackBerry OS, and Apple Computer's iPhone using iPhone OS.

A web browser can be used to bring information resources to the user. This process begins when the user inputs a web address or URI into the browser. The prefix of the URI determines how the URI will be interpreted. The most commonly used kind of URI starts with “http:” which identifies a resource to be retrieved over the Hypertext Transfer Protocol (HTTP). Many browsers also support a variety of other prefixes, such as “https:” for HTTPS, “ftp:” for the File Transfer Protocol, and “file:” for local files. In the case of http, https, file, and other prefixes, once the resource has been retrieved the web browser will display it. Hyper Text Markup Language (HTML) is passed to the browser's layout engine to be transformed from markup to an interactive document. Aside from HTML, web browsers can generally display any kind of content that can be part of a web page. Most browsers can display images, audio, video, animation and XML files, and generally have plug-ins to support Flash applications and Java applets.

In certain embodiments, information resources may contain hyperlinks to other information resources. Each link may contain the URI of a resource to go to. When a link is clicked, the browser navigates to the resource indicated by the link's target URI, and the process of bringing content to the user begins again.

In some embodiments, the standard web page description language, i.e., HTML, provides basic document formatting and permits one skilled in the art to create and specify “links” or “hyperlinks” to other servers and files. Obtaining a web page or connecting to a website generally requires the specification of a URI using an HTML-compliant client browser. After specifying the URI, the client computer or user terminal 5, 6 or 7 initiates a request to the web server 3 or 4 identified in the link and connects to the website and receives a web page. In some embodiment, the request by client computer or user terminal 5, 6 or 7 to the web server 3 or 4 via the link may be communicated via a TCP/IP (Transfer Control Protocol/Internet Protocol) communication. In certain embodiment, other network connections or Internet protocols may be used.

Although exemplary embodiments of the system disclosed herein are described based on the arrangements illustrated in FIG. 1 and FIG. 2, it is noted that the invention is not limited in scope in those arrangement and other types of system connections may be employed. For example, a plurality of client computers and terminals may be connected to a server which in turn connects to the internet. In accordance with this embodiment, the server provides certain information that causes the cursor image on the screen or video monitor of the client computer and terminal to display a digital image as specified by the computer server system. As a result, the computer server system remotely replaces the cursor image with the selected digital image. The selected digital image may correspond to the actual content of the data being provided to the viewer or user. Furthermore, regardless of the actual content of the data being provided to the viewer or user, the selected digital image may be specified by the computer server system such that a plurality of client computers and terminals at a desired point in time receive appropriate instructions to display the selected digital image as a cursor image.

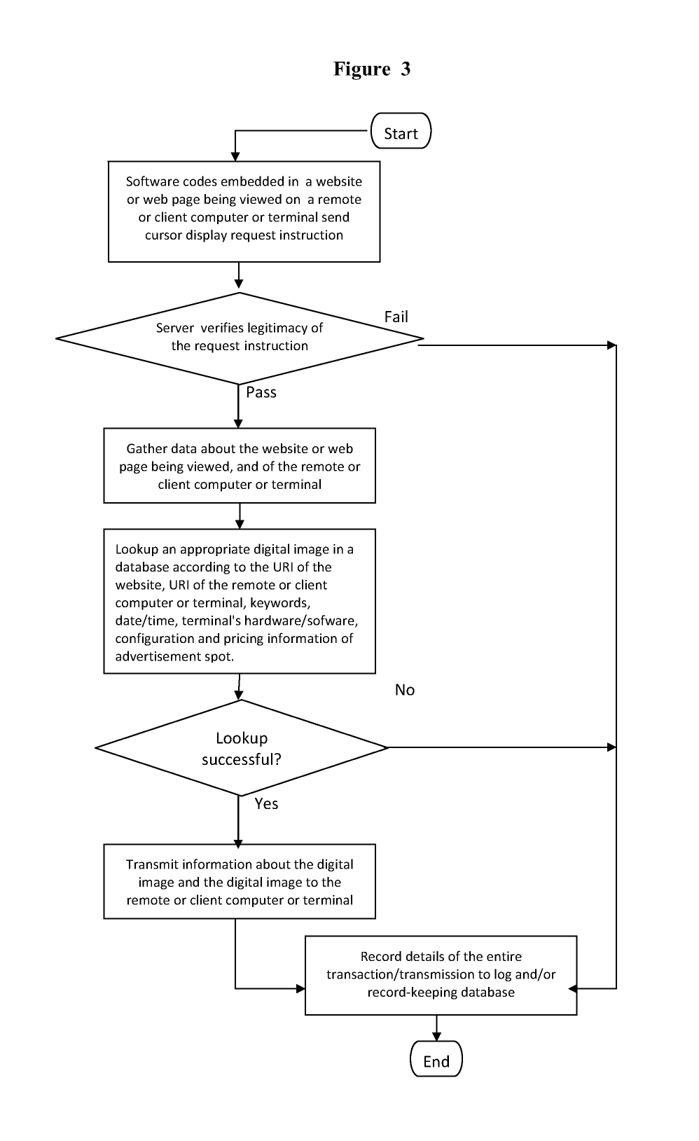

Referring to FIG. 3, when a website or web page is retrieved, the software codes embedded in the website or web page being viewed on a remote or client computer or terminal send one or more cursor display request instructions to the computer server system disclosed herein. The computer server system then verifies whether the cursor display request instructions are properly requested. If the request is not proper, the computer server system will merely record the transaction into its internal log and/or a record-keeping database. If the request is proper, the computer server system may gather information or data about the website or web page being viewed, and information of the remote or client computer or terminal. The computer server system may lookup or search for an appropriate digital image in the database residing in the computer server system according to a number of criteria such as, but not limited to, the URI of the website or web page, the URI of the client computer or terminal, the browsing date and/or time, the configuration, hardwares and/or software (e.g., the operating system, browsers, and applications) of the client computer or terminal, pricing information of one or more advertisement spots; and keywords comprise information about the above-mentioned criteria. In some embodiments, the keywords comprise information related to the manufacturer, operating system, and configuration of the client computer or terminal; and information related to hardwares, browsers, and applications installed on the client computer or terminal. In other embodiments, the keywords comprise statistics or data that describe the configuration of the client computer or terminal. In further embodiments, the keywords comprise text describing the type of content on one or more affiliated web pages or websites. In still further embodiments, the keywords comprise text of syntax that is specially defined and understandable by the first set of software codes.

If the lookup of the appropriate digital image is not successful, the computer server system will merely record the transaction into its internal log and/or the record-keeping database. If the lookup is successful, the computer server system may transmit information about the digital image and the digital image to the remote or client computer or terminal and may record the details of the entire transaction into its internal log and/or the record-keeping database. The digital image may be in any shape, appearance, form or format known to a skilled artisan. In some embodiments, the digital image is a static image or an animated cursor.

In certain embodiments, the movements of the cursor image or the digital image are tracked by the second set of software codes and the data related to the movements of the cursor image or the digital image may be sent back to the computer server system for further processing by the second set of software codes. In some embodiments, the data related to the movements of the cursor image or the digital image comprise a record of the positions and movements of the cursor image or the digital image and buttons pressed. In other embodiments, the digital image is configured to respond to the movements of a user of the client computer or terminal and to trigger one or more applications on the client computer or terminal.

In some embodiments, the client computer or terminal does not comprise a mouse and comprises a touch screen control. In other embodiments, the client computer or terminal comprises a detector that tracks eyeball movements of a user of the client computer or terminal and use the eyeball movements to command the digital image or the cursor image.

Any computer that is designated to run one or more specific server applications can be used as the computer server system disclosed herein. In some embodiments, the computer server system disclosed herein comprises one or more servers. In other embodiments, the computer server system comprises one server. In certain embodiments, the computer server system comprises two or more servers. In further embodiments, each of the two or more servers independently runs a server application, which may be the same as or different from applications running in the other servers.

The computer server system may comprise or may be any computer that is configured to connect to the internet by any connection method disclosed herein and to run one or more server applications known to a skilled artisan. The computer server system may comprise a mainframe computer, a minicomputer or workstation, or a personal computer disclosed herein.

When a server is designated to run one server application, the server may be named for that application. Some non-limiting examples of such designated servers include file server, database server, communications server, backup server, print server, mail server, web server, FTP server, application server, VPN server, DHCP server, DNS server, WINS server, logon server, security server, domain controller, backup domain controller, proxy server, firewall server, etc. In certain embodiments, the computer server system of the system disclosed herein comprises one or more of the designated servers disclosed herein.

The computer server system disclosed herein can be designated to run one or more server applications. In certain embodiments, the computer server system comprises two or more servers and the server applications can be divided among the servers. In some embodiments, every and all server applications can be run concurrently on a single server. In other embodiments, two or more servers may be required for each server application under heavy loading.

In some embodiments, the computer server system disclosed herein comprises an application server that delivers applications to client computers or devices. Generally, an application server handles most, if not all, of the business logic and data access of the application (a.k.a. centralization). The term application server applies to all platforms including the Sun Microsystems J2EE platform and servers of web-based applications, such as integrated platforms for e-commerce, content management systems, affiliate management systems, and simple web-site builders.

In certain embodiments, the computer server system disclosed herein comprises a communications server that operates as a carrier-grade common platform for a wide range of communications applications. In certain embodiments, the communications server may base on industry-managed standards such as AdvancedTCA®, MicroTCA™, Carrier Grade Linux and Service Availability™ Forum.

In some embodiments, the system disclosed herein or the computer server system disclosed herein comprises a database server dedicated to running a database program. A database program refers to a program that provides database services to other computer programs or computers. In certain embodiments, the database management systems (DBMS's) of the database server disclosed herein may provide database server functionality. In certain embodiments, the DBMS's of the database server relies on the client-server model for database access.

The database suitable for the system disclosed herein can be any collection of information organized in such a way that a computer program can select one or more desired pieces of information and provide them to users. The information in the database can comprise text, numeric, image, sound, video, data, or a combination thereof. The database disclosed herein can be based on any database model known to a skilled artisan. Some non-limiting examples of suitable database models include flat model, hierarchical model, network model, relational model, dimensional model, entity-relationship, and objectional database models (e.g., object-relational model and object model). In some embodiments, the database model used herein is the relational model, the hierarchical model, or the network model.

In other embodiments, the computer server system disclosed herein comprises a proxy server which services the requests of its clients by making requests to other servers. A client connected to the proxy server, may request a file, connection, web page, or other resource available from a different server. In some embodiments, the proxy server may provide the resource by connecting to a specified server. In further embodiments, the proxy server may alter the client's request or the specified server's response. In certain embodiments, a proxy server may service the request without contacting the specified server. In other embodiments, a proxy server can be placed in the user's local computer or at specific key points between the user and the destination servers or the internet.

In certain embodiments, the computer server system disclosed herein comprises a gateway server that passes all requests and replies unmodified.

In some embodiments, the computer server system disclosed herein comprises a fax server that run a fax server application. The fax server may accept documents from users, convert them into faxes, and transmit them, as well as to receive fax calls and either store the incoming documents or pass them on to users. In certain embodiments, fax server users may communicate with the fax server in several ways including through either a local network or the Internet.

In other embodiments, the computer server system disclosed herein comprises a file server on which a user can map or mount a disk drive or directory so that the directory appears to be on the user's computer at which the user is sitting. In certain embodiments, the user can read or write a file as though it were part of the file system of the user's computer. In certain embodiments, files and directories on the file server can be accessed using a particular protocol, such as WebDAV, SMB, CIFS, NFS, Appletalk or their mutations.

In certain embodiments, the computer server system disclosed herein comprises a game server used by game clients. Generally, a video game played over the internet requires a connection to a game server.

In some embodiments, the computer server system disclosed herein comprises a client-server which separates a client from a server. The client-server architecture is generally implemented over a computer network. Each client or server connected to the network may be referred to as a node. In certain embodiments, the client-server architecture employs only two types of nodes: clients and servers. This type of client-server architecture may be referred to as two-tier. Each client software can send data requests to one or more connected servers which can accept these requests, process them, and return the requested information to the client. In certain embodiments, the client software include a web browser.

The system disclosed herein comprises one or more web servers. Any web server known to a skilled artisan can be used herein. In some embodiments, the one or more web servers run a computer program that is responsible for accepting HTTP requests from clients, e.g., web browsers, and serving the clients HTTP responses along with optional data contents, which usually are web pages such as HTML documents and linked objects such as images, video clips, audio signals, animation codes and the like.

In certain embodiments, various other internal or external components may be added to the computer server system. Some non-limiting examples of suitable internal components include a graphics processors, USB adaptors, IEEE 1394 adaptors, S-video adaptors, RS-232 adaptors, ethernet adaptors, video decorders, audio decorders, and data decorders. Some non-limiting examples of suitable external components include mouses, pointers, keyboards, touch pad control, mass storage devices, smart card readers, speakers, and printers. Such internal or external components may be connected via a physical connection or by a wireless connection (e.g., a wireless mouse or keyboard).

In certain embodiments, the execution of software instructions occurs within the computer server system and the output may be loaded into the client computer or terminal as an digital image which appears on the screen or display device the client computer or terminal.

In some embodiments, the software instructions or codes disclosed herein are written in the Hypertext Markup Language (HTML). In certain embodiments, the software codes are written in the Java programming languages including Personal Java and JavaScript, developed by Sun Microsystems, Inc, Palo Alto, Calif. In other embodiments, the software codes are written in the C++ programming language. In some embodiments, the software instructions or codes disclosed herein are written in the XML. In some embodiments, the software instructions or codes disclosed herein are written in CSS. In some embodiments, the software instructions or codes disclosed herein are written in PHP. In some embodiments, the software instructions or codes disclosed herein are written in Adobe Actionscirpt. In some embodiments, the software instructions or codes disclosed herein are written in Adobe Flash. In further embodiments, the software codes are written by a combination of the languages disclosed herein or other languages that may be substituted within the scope of the present invention.

The client computers or terminals disclosed herein may comprise an internal screen or display device that provides a visual presentation of images and texts that are acquired, stored, or transmitted in various forms. In some embodiments, the screen or display device may further provide audio outputs. The screen or display device may be a display component of an external TV set, a computer monitor, a projector or a combination thereof.

Both the internal or external screen or display device suitable for the system disclosed herein may be in any format or technology known to a skilled artisan. Some non-limiting examples of suitable display devices or technologies include CRT displays, digital light processing (DLP) displays, plasma display panels (PDPs), liquid crystal displays (LCDs), such as thin film transistor (TFT-LCD) displays and HPA-LCD displays, light-emitting diode (LED) displays, organic light-emitting diode (OLED) displays, electroluminescent displays (ELDs), surface-conduction electron-emitter displays (SEDs), field emission displays (FEDs), liquid crystal on silicon (LCOS or LCoS) displays, interferometric modulator displays (IMODs), laser TVs, electronic papers, and rear projection displays that may be CRT-based, LCD-based, DLP-based, and LCOS-based. One or more of the above-mentioned display device may be use as the display component in television sets or projectors (TVs), such as standard-definition television (SDTVs), enhanced-definition televisions (EDTVs) and high-definition televisions (HDTVs), computer monitors, laptop computers, portable DVD players or a combination thereof.

In some embodiments, the display device is or comprises a cathode ray tube (CRT) display. Generally, the CRT display comprises an evacuated glass envelope containing an electron gun (a source of electrons) and a fluorescent screen. When electrons from the electron gun strike the fluorescent screen, light is emitted from the screen. The electrons may be deflected and modulated in a way which causes them to display an image on the screen. Internal or external means may be used to accelerate and deflect the electrons. Any CRT display known to a skilled artisan can be used for the system disclosed herein.

In certain embodiments, the display device is or comprises a digital light processing (DLP) display. The DLP generally comprises a video projector wherein the image is created by microscopically small mirrors laid out in a matrix on a semiconductor chip, known as a Digital Micromirror Device (DMD). Each mirror represents one pixel in the projected image. These mirrors can be repositioned rapidly to reflect light either through the lens or on to a heatsink (“light dump”). The rapid repositioning of the mirrors can allow the DMD to vary the intensity of the light being reflected out through the lens. Any DLP display known to a skilled artisan can be used for the system disclosed herein. In some embodiments, the DLP display is a single-chip DLP projector. In other embodiments, the DLP display is a three-chip DLP projector. In further embodiments, the DLP display comprise a DLP chipset from Texas Instruments of Dallas, Tex., or from Fraunhofer Institute of Dresden, Germany.

In some embodiments, the display device is or comprises a plasma display panel (PDP). The PDP generally comprises many tiny cells located between two panels of glass hold an inert mixture of noble gases (neon and xenon). The gas in the cells is electrically turned into a plasma which then excites phosphors to emit light. Any PDP known to a skilled artisan can be used for the system disclosed herein.

In certain embodiments, the display device is or comprises a liquid crystal display (LCD). The LCD generally comprises a thin, flat display device made up of a plurality of color or monochrome pixels arrayed in front of a light source or reflector. It generally uses very small amounts of electric power, and is therefore suitable for use in battery-powered electronic devices. Any LCD known to a skilled artisan can be used for the system disclosed herein.

In other embodiments, the display device is or comprises a light-emitting diode (LED) display or panel. The LED display generally comprises a plurality of LED's, each of which independently emits incoherent narrow-spectrum light when electrically biased in the forward direction of the p-n junction. Generally, there are two types of LED panels: conventional, using discrete LEDs, and surface mounted device (SMD) panels. A cluster of red, green, and blue diodes is driven together to form a full-color pixel, usually square in shape. Any LED display known to a skilled artisan can be used for the system disclosed herein.

In certain embodiments, the display device is or comprises an organic light-emitting diode (OLED) display. The OLED display generally comprises a plurality of organic light-emitting diodes. An organic light-emitting diode (OLED) refers to any light-emitting diode (LED) having an emissive electroluminescent layer comprises a film of organic compounds. The electroluminescent layer generally contains a polymer substance that allows suitable organic compounds to be deposited in rows and columns onto a flat carrier to form a matrix of pixels. The matrix of pixels can emit light of different colors. Any OLED display known to a skilled artisan can be used for the system disclosed herein.

In some embodiments, the display device is or comprises an electroluminescent display (ELD). Electroluminescence (EL) is an optical and electrical phenomenon where a material emits light in response to an electric current passed through it, or to a strong electric field. The ELD generally is created by sandwiching a layer of electroluminescent material such as GaAs between two layers of conductors. When current flows, the electroluminescent material emits radiation in the form of visible light. Any ELD known to a skilled artisan can be used for the system disclosed herein.

In other embodiments, the display device is or comprises a surface-conduction electron-emitter display (SED). The SED generally comprises a flat panel display technology that uses surface conduction electron emitters for every individual display pixel. The surface conduction emitter emits electrons that excite a phosphor coating on the display panel. Any SED known to a skilled artisan can be used for the system disclosed herein. In some embodiments, the SED comprises a surface conduction electron emitter from Canon, Tokyo, Japan.

In certain embodiments, the display device is or comprises a field emission display (FED). The FED generally uses a large array of electron emitters comprising fine metal tips or carbon nanotubes, with many positioned behind each phosphor dot in a phosphor coating, to emit electrons through a process known as field emission. The electrons bombard the phosphor coatings to provide visual images. Any FED known to a skilled artisan can be used for the system disclosed herein.

In some embodiments, the display device is or comprises a liquid crystal on silicon (LCOS or LCoS) display. The LCOS display generally is a reflective technology similar to DLP projectors, except that the former uses liquid crystals instead of individual mirrors used in the latter. The liquid crystals may be applied directly to the surface of a silicon chip coated with an aluminized layer, with some type of passivation layer, which is highly reflective. Any LCOS display known to a skilled artisan can be used for the system disclosed herein. In some embodiments, the LCOS display comprises a SXRD chipset from Sony, Tokyo, Japan. In some embodiments, the LCOS display comprises one or more LCOS chips.

In other embodiments, the display device is or comprises a laser TV. The laser TV generally is a video display technology using laser optoelectronics. Optoelectronics refers to the study and application of electronic devices that interact with light wherein light includes invisible forms of radiation such as gamma rays, X-rays, ultraviolet and infrared. Any laser TV known to a skilled artisan can be used for the system disclosed herein.

In certain embodiments, the display device is or comprises an interferometric modulator display (IMOD). Generally, the IMOD uses microscopic mechanical structures that reflect light in such a way that specific wavelengths interfere with each other to create vivid colors, like those of a butterfly's wings. This can produce pure, bright colors using very little power. Any IMOD known to a skilled artisan can be used for the system disclosed herein.

In some embodiments, the display device is or comprises an electronic paper, e-paper or electronic ink. The electronic paper generally is designed to mimic the appearance of regular ink on paper. Unlike a conventional flat panel display, which uses a backlight to illuminate its pixels, electronic paper generally reflects light like ordinary paper and is capable of holding text and images indefinitely without drawing electricity, while allowing the image to be changed later. Unlike traditional displays, electronic paper may be crumpled or bent like traditional paper. Any electronic paper known to a skilled artisan can be used for the system disclosed herein.

In some embodiments, web pages or websites that are affiliated contain hints or keywords that allow the computer server system to detect and decide what digital cursor image to display. Such hints or keywords may also contain other statistics or data that describes the end-user's computer configuration such as, but not limited to: manufacturer, version and name of browser, operating system, Java® and other software installed on the system, and, hardware information and configuration.

In certain embodiments, the digital cursor which replaces the default cursor is a static digital image. In other embodiments, where it is support, the digital cursor is an animated cursor.

In some embodiments, the digital cursor which replaces the default cursor may detect the user's interaction with the mouse and send such data back to servers for further processing. Such data may include trace of the user's mouse positions and movements; and buttons pressed. In certain embodiments, such collected data may be used to determine what advertisements are to be placed on the web page concerned, and/or the rate to be charged for advertisements in different areas on the web page concerned.

In some embodiments, the digital cursor which replaces the default cursor may also be configured to respond to certain user movements (commonly called mouse gestures) and trigger other software on the user's computer. For examples, when the user makes a circular movement or gesture with the mouse, the browser loads a specific web page that is associated with the cursor image being displayed, i.e., the advertiser's website or the product's website.

While most computer systems nowadays use a “mouse” as the pointing device, future computer systems may not have a mouse at all. Some companies are researching using detectors that track a user's eyeball movements and translate such movements into commands that control the cursor pointer on computer systems. Other companies are researching using electrodes to detect skin nerve signals and use such signals to control computer systems. Although the current invention involves the mouse cursor pointer, most of the invention actually works through the cursor pointer on the screen regardless of whether the human-controlled input device is a mouse or not. For that matter, the input device could be some of the previously mentioned devices still in research.

In one aspect, provided herein is a system for transmitting a digital image for the purpose of replacing or overriding the cursor being displayed at a client computer or terminal with at least one screen, comprising:

a) computer software codes, stored in a computer readable medium, residing on a computer server system with at least one network connection, able to receive and transmit data through the said network connection;

b) computer software codes, stored in a computer readable medium, operable to process at least one cursor display request instruction, processing said cursor display request instruction overriding said cursor being displayed at said client computer screen;

c) a database, stored in a computer readable medium, that stores a mapping of information allowing network domain addresses to be paired or coupled with a corresponding digital image;

d) a database, stored in a computer readable medium, operable to interact with said software code to process at least one cursor display request instruction, processing the network domain address of the website being viewed on the said client computer to match against the said mapping information to identify and locate the said digital image; and

e) computer software codes, stored in a computer readable medium, operable to interact with said database to transmit said digital image to said client computer.

In another aspect, provided herein is a system for selecting a digital image according to a predetermined mapping of information, and transmitting the said digital image for the purpose of replacing or overriding the cursor being displayed at a client computer or terminal with at least one screen, comprising:

a) computer software codes, stored in a computer readable medium, residing on a computer server system with at least one network connection, able to receive and transmit data through the said network connection;

b) computer software codes, stored in a computer readable medium, operable to process at least one cursor display request instruction, processing said cursor display request instruction overriding said cursor being displayed at said client computer screen;

c) a database, stored in a computer readable medium, that stores the said mapping of information allowing network addresses to be paired or coupled with a corresponding digital image;

d) a database, stored in a computer readable medium, operable to interact with said software code to process at least one cursor display request instruction, processing the network domain address of the website being viewed on the said client computer to match against the said mapping information to identify and locate the said digital image; and

e) computer software codes, stored in a computer readable medium, operable to interact with said database to transmit said digital image to said client computer.

As demonstrated above, embodiments of the invention provide various systems for overriding or replacing the default displayed cursor image on a client computer or terminal. While the invention has been described with respect to a limited number of embodiments, the specific features of one embodiment should not be attributed to other embodiments of the invention. No single embodiment is representative of all aspects of the invention. Variations and modifications from the described embodiments exist. The appended claims intend to cover all such variations and modifications as falling within the scope of the invention.

All publications and patent applications mentioned in this specification are herein incorporated by reference to the same extent as if each individual publication or patent application was specifically and individually indicated to be incorporated by reference. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A system for transmitting a digital image to replace a cursor image associated with a website or web page displayed at a client computer or terminal, the system comprising:
a) a computer server system connected to the internet;
b) a database containing mapping information for pairing, matching or coupling the URI of the website or web page with the digital image;
c) a first set of software codes operable to receive and transmit instructions or data through the internet;
d) at least one web server connected to the internet, wherein the web server hosts the web page or website; and
e) a second set of software codes operable to generate at least one cursor display request instruction and to transmit the cursor display request instruction to the computer server system,
wherein the database and the first set of software codes reside in the computer server system, and wherein the second set of software codes is embedded in the web page or website, and wherein the first set of software codes is further operable to process the cursor display request instruction, to search the database for the digital image corresponding to the URI, and to transmit the digital image to replace the cursor image displayed at the client computer or terminal.

2. The system of claim 1, further comprising a third set of computer software code operable to interact with the database to transmit the digital image to the client computer or terminal.

3. The system of claim 1, wherein the database contains mapping information for pairing, matching or coupling the URI and one or more keywords with the digital image.

4. The system of claim 3, wherein the one or more keywords comprise statistics or data that describe the configuration of the client computer or terminal.

5. The system of claim 3, wherein the one or more keywords comprise information related to the manufacturer, operating system, and configuration of the client computer or terminal; and information related to hardwares, browsers, and applications installed on the client computer or terminal.

6. The system of claim 3, wherein the one or more keywords comprise text describing the type of content on one or more affiliated web pages or websites.

7. The system of claim 3, wherein the one or more keywords comprise text of syntax that is specially defined and understandable by the first set of software codes.

8. The system of claim 1, wherein the digital image is a static image.

9. The system of claim 1, wherein the digital image is an animated cursor.

10. The system of claim 1, wherein movements of the cursor image or the digital image are tracked by the second set of software codes and data related to the movements of the cursor image or the digital image are sent back to the computer server system for further processing by the first set of software codes.

11. The system of claim 10, wherein the data related to the movements of the cursor image or the digital image comprise a record of the positions and movements of the cursor image or the digital image and buttons pressed.

12. The system of claim 1, wherein the digital image is configured to respond to the movements of a user of the client computer or terminal and to trigger one or more applications on the client computer or terminal.

13. The system of claim 1, the client computer or terminal does not comprise a mouse and comprises a touch screen control.

14. The system of claim 1, the client computer or terminal comprises a detector that tracks eyeball movements of a user of the client computer or terminal and use the eyeball movements to command the digital image or the cursor image.

15. A system for transmitting a digital image to replace a cursor image associated with a website or web page displayed at a client computer or terminal, the system comprising:
a) a computer server system connected to the internet;
b) a first set of software codes operable to receive and transmit instructions or data through the internet;
c) a database server system connected to the internet or to the computer server system;
d) a database containing mapping information for pairing, matching or coupling the URI of the website or web page with the digital image;
e) at least one web server connected to the internet, wherein the web server hosts the web page or website; and
f) a second set of software codes operable to generate at least one cursor display request instruction and to transmit the cursor display request instruction to the computer server system,
wherein the first set of software codes resides in the computer server system, the database resides in the database server, and the second set of software codes is embedded in the web page or website, and wherein the first set of software codes is further operable to process the cursor display request instruction, to search the database for the digital image corresponding to the URI, and to transmit the digital image to replace the cursor image displayed at the client computer or terminal.

16. The system of claim 15, wherein the database contains mapping information for pairing, matching or coupling the URI and one or more keywords with the digital image.

17. The system of claim 16, wherein the one or more keywords comprise statistics or data that describe the configuration of the client computer or terminal.

18. The system of claim 16, wherein the one or more keywords comprise information related to the manufacturer, operating system, and configuration of the client computer or terminal; and information related to hardwares, browsers, and applications installed on the client computer or terminal.

19. The system of claim 16, wherein the one or more keywords comprise text describing the type of content on one or more affiliated web pages or websites.

20. The system of claim 15, wherein the digital image is a static image or an animated cursor.
